(19) United States
(12) Patent Application Publication
(10) Pub. No.: US 2004/0080852 A1
(43) Pub. Date: Apr. 29, 2004

(54) Disc caddy feeder system with caddy gripper for data storage devices

(75) Inventors: James R. Jenkins, Yukon, OK (US); Roger A. Jessen, Morman, OK (US)

Correspondence Address: Seagate Technology LLC, Intellectual Property - OKM178, 10321 West Reno, Oklahoma City, OK, 73127-7140, US

(73) Assignee: Seagate Technology LLC, Scotts Valley, CA

(21) Appl. No.: 10/687,794

(22) Filed: Oct. 17, 2003

Related U.S. Application Data
(60) Provisional application No. 60/419,483, filed on Oct. 18, 2002.
(60) Provisional application No. 60/419,482, filed on Oct. 18, 2002.

(51) Int. Cl. G11B 17/00

(52) U.S. Cl. 360/69

(57) ABSTRACT

A disc presentation apparatus executing a method of presenting the disc by using a caddy gripper is disclosed. The disc presentation apparatus includes; a frame supporting an in-feed conveyor advancing a disc caddy with a disc, a caddy escapement securing the disc caddy from the in-feed conveyor and transporting the disc caddy to a caddy feed. The caddy feed includes the caddy gripper secured to a feed elevator, which indexes the disc to a predetermined substantially fixed location and transfers the disc caddy to an out-feed conveyor. The caddy gripper extracts the disc caddy from the caddy escapement and includes; a gripper slide assembly advancing a gripper plate into mating contact with the disc caddy, a caddy locating assembly aligning the disc caddy relative to the gripper plate, and an active jaw assembly engaging a first side of the disc caddy thereby gripping the disc caddy adjacent the gripper plate.

### RELATED APPLICATIONS

This application claims priority to U.S. Provisional Application No. 60/419,483 filed Oct. 18, 2002, entitled Automated Disc Caddy Feed System, and to U.S. Provisional Application No. 60/419,482 filed Oct. 18, 2002, entitled Automated Disc Caddy Gripper.

### FIELD OF THE INVENTION

This invention relates generally to the field of magnetic data storage devices, and more particularly, but not by way of limitation, to a disc caddy feeder system having a disc caddy gripper for use in presenting storage discs during data storage device assembly operations.

### BACKGROUND

One key component of many electronic systems is a device, such as a data storage device (DSD) to store and retrieve large amounts of user data in a fast and efficient manner. One method in which DSDs store digital data is in magnetic form on recording surfaces of one or more rigid data storage discs (discs) affixed to a spindle motor for rotation at a constant high speed.

Among the challenges associated with data storage devices and data storage device assembly processes are cost effective techniques for the presentation of the discs during the assembly process. To minimize the exposure of the discs to contaminants and handling damage during the production process, it has been found useful to contain the discs within the disc shipping cassettes, which include a disc caddy portion. However, under prior production process techniques, an operator would prepare the disc caddy for use in the production process by deliding the shipping cassette and positioning each caddy for use within a disc stacking station. At times operators would cause an untimely delay in the supply of the discs, or mishandle the caddy during the positioning operation causing discs to escape from the caddy and fall to the production floor causing damage to the discs.

As such, challenges remain and a need persists for cost effective techniques for managing the material handling functions associated with the presentation of discs for use during assembly operations of data storage devices.

### SUMMARY OF THE INVENTION

In accordance with preferred embodiments, the present invention is directed to a disc presentation apparatus, a method of presenting the disc, and an apparatus for gripping a disc caddy. The disc presentation apparatus includes a frame supporting an in-feed conveyor, which advances a disc caddy with at least one disc confined therein to a caddy escapement. The caddy escapement secures the disc caddy from the in-feed conveyor and transports the disc caddy to a caddy feed. Also included in the disc presentation apparatus is an out-feed conveyor, which preferably receives empty disc caddies from the caddy feed and transports them to an outer extent of the presentation apparatus.

The steps of the disc presentation method preferably include; positioning a disc caddy confining a disc on an in-feed conveyor, securing the disc caddy with a caddy escapement, transferring the disc caddy secured by the caddy escapement to a caddy feed, extracting the disc caddy from the caddy escapement with means for gripping a disc caddy, indexing the disc to a predetermined substantially fixed location, and transferring the disc caddy to an out-feed conveyor.

The means of gripping the disc caddy is the apparatus for gripping the disc caddy which preferably includes; a slide mount, a gripper slide assembly attached to the slide mount, a gripper plate secured to the gripper slide assembly, an active jaw assembly preferentially fastened to the gripper plate and a caddy locating assembly. Preferably the gripper slide assembly advances the gripper plate into mating contact with the disc caddy, the caddy locating assembly aligns the disc caddy relative to the gripper plate, and the active jaw assembly engages a first side of the disc caddy thereby gripping the disc caddy adjacent the gripper plate.

These and various other features and advantages that characterize the claimed invention will be apparent upon reading the following detailed description and upon review of the associated drawings.

### BRIEF DESCRIPTION OF THE DRAWINGS

FIG. 1 is a partial cutaway top plan view of a data storage device (DSD) that incorporates discs provided by a disc caddy feeder system with caddy gripper of the present invention.

FIG. 2 is a perspective view of a disc cassette.

FIG. 3 is a plan view of the disc caddy portion of the disc cassette of FIG. 2.

FIG. 4 is a top perspective view of the disc caddy feeder system with caddy gripper used during the assembly process of the DSD of FIG. 1.

FIG. 5 is a top perspective view of a pair disc caddy conveyors of the disc caddy feeder system with caddy gripper of FIG. 4.

FIG. 6 is a top perspective exploded view of the first half of the disc caddy feeder system with caddy gripper of FIG. 4.

FIG. 7 is a top perspective exploded view of an alignment assembly of the first half of the disc caddy feeder system with caddy gripper of FIG. 5

FIG. 8 is a top perspective view of a caddy escapement of the caddy feeder system with caddy gripper of FIG. 4.

FIG. 9 is a top perspective exploded view of the caddy escapement of FIG. 8.

FIG. 10 is a top perspective view of a caddy gripper of the caddy feeder system with caddy gripper of FIG. 4.

FIG. 11 is a top perspective exploded view of the caddy gripper of FIG. 10.

FIG. 12 is a flow diagram showing steps for using the disc caddy feeder system with caddy gripper during the assembly process of the DSD of FIG. 1

### DETAILED DESCRIPTION

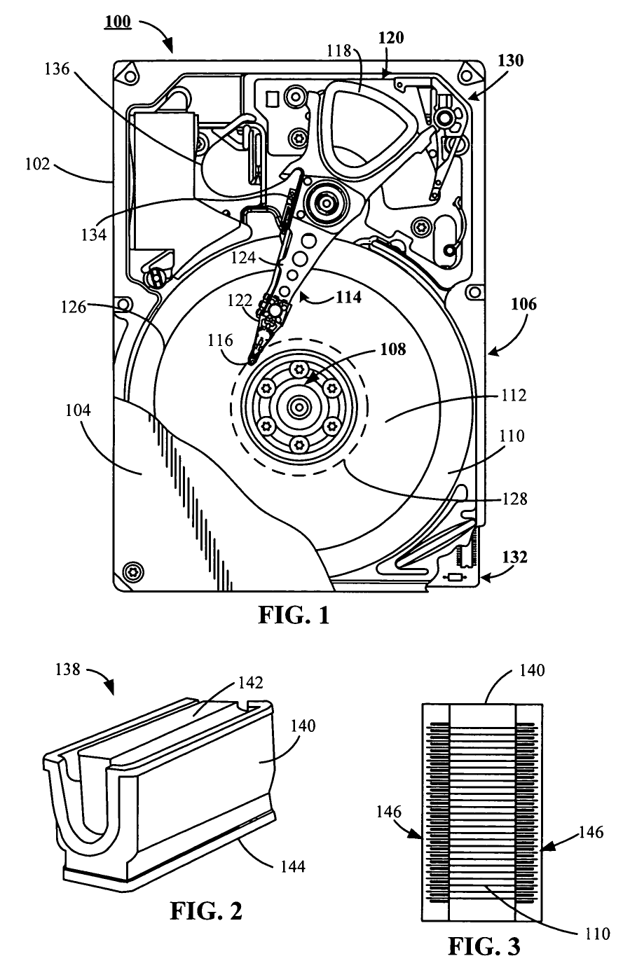

Referring now to the drawings, FIG. 1 provides a top plan view of a data storage device (DSD) 100. The DSD 100 includes a base deck 102 cooperating with a top cover 104 (shown in partial cutaway) to form a sealed housing for a mechanical portion of the DSD 100, referred to as a head-disc assembly (HDA) 106.

A spindle motor assembly (motor) 108 rotates a number of data storage discs (disc) 110 with a magnetic recording surface (surfaces) 112 at a substantially constant operational speed. An actuator assembly (actuator) 114 supports and rotates a number of read/write heads (heads) 116 into a data exchange relationship adjacent the magnetic recording surfaces 112 when current is applied to a coil 118 of a voice coil motor (VCM) 120. A head suspension 122 provides a predetermined spring force on the head 116 to maintain the proper data exchange relationship between the head 116 and the disc 110 during operation of the DSD 100. Additionally, the head suspension 122 serves to connect the head 116 with an actuator arm 124 of the actuator 114.

During operation of the DSD 100, the actuator 114 moves the heads 116 into the data exchange relationship with the disc 110, i.e., the actuator 114 moves the heads 116 to data tracks 126 (one shown) on the surfaces 112 to write data to and read data from the discs 110. When the DSD 100 is deactivated, the actuator 114 positions the heads 116 adjacent a home position 128, and is confined by latching a toggle latch 130. However, alternative means for restraining the actuator 114 may be employed, for example, a ramp load/unload mechanism (not shown) may be incorporated to constrain movement of the actuator 114 during periods of inactivity of the DSD 100.

During data transfer operations of the DSD 100; the heads 116 transfer data to and from the magnetic recording surfaces 112 to a printed circuit board assembly 132. The data are processed by a preamplifier 134 and passed to the printed circuit board assembly 132 through a flex circuit 136.

FIG. 2 shows a disc cassette 138 including disc caddy 140, a caddy top cover 142, and a caddy bottom cover 144. The disc caddy cradles discs 110 (of FIG. 1) during transport while the caddy top cover 142 and the caddy bottom cover 144 preclude particulates from contaminating the discs 110.

FIG. 3 shows a plurality of disc retention channels 146 separating each of the discs 110 within the disc caddy 140. FIG. 3 also shows a preferred orientation of the disc caddy 140 for presenting the discs 110 during the assembly process of the DSD 100 (of FIG. 1).

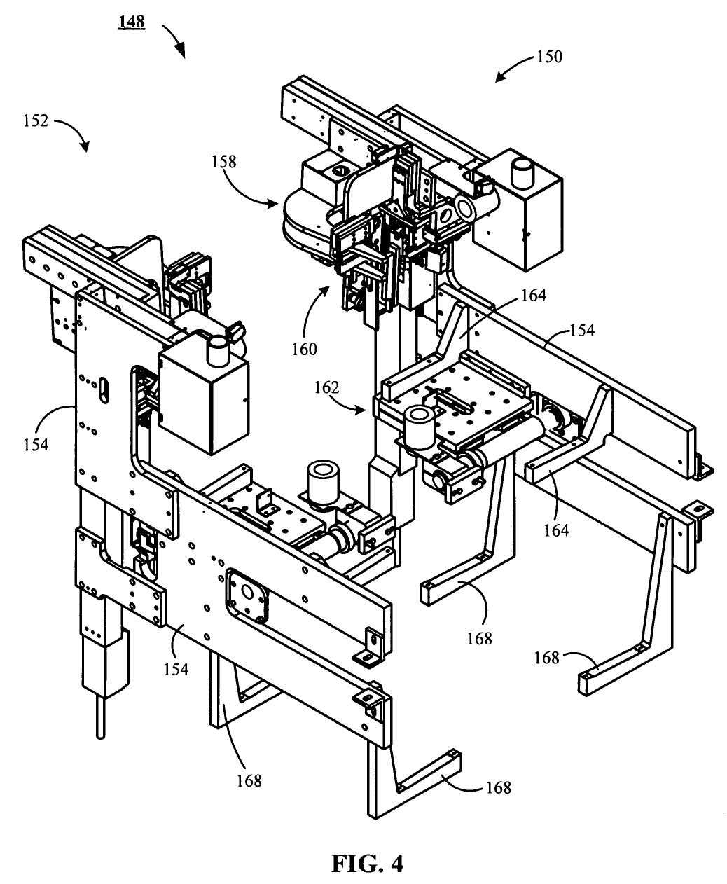

FIG. 4 shows a disc caddy feeder system with a caddy gripper 148, which preferably includes a first disc presentation apparatus 150 and a second disc presentation apparatus 152. The second disc presentation apparatus 152 is preferably substantially a mirror image of the first disc presentation apparatus 150. Each disc presentation apparatus shares substantially the same components and preferably only differ as a result of the sequence and orientation of those components used during the assembly process of each disc presentation apparatus. As such, discussions directed to the assemblies, components, and operational capabilities of the first disc presentation apparatus 150 are substantially applicable to the assemblies, components, and operational capabilities of the second disc presentation apparatus 152, and the converse is true.

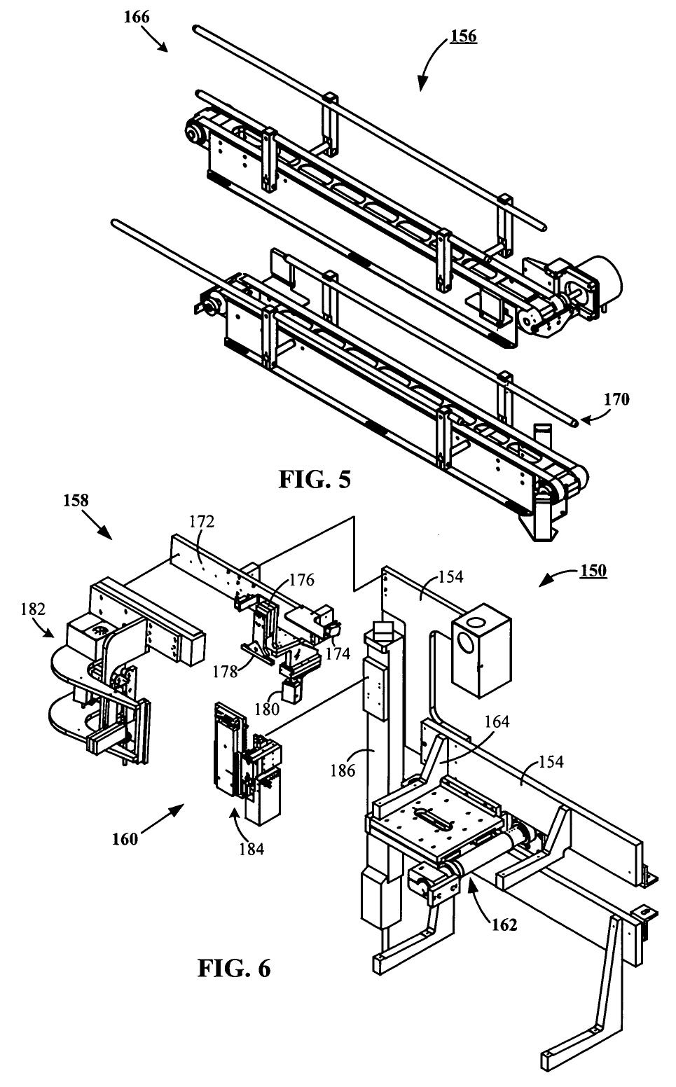

Each disc presentation apparatus includes a frame 154 supporting a pair of caddy feed conveyors 156 (of FIG. 5), a caddy escapement 158, a caddy feed 160, and an alignment assembly 162. Attached to the frame 154 is a pair of in-feed conveyor supports 164, to which an in-feed conveyor 166 (of FIG. 5) is secured, and a pair of out-feed conveyor supports 168, to which an out-feed conveyor 170 (of FIG. 5) is secured.

Preferably, the in-feed conveyor 166 transports the disc caddy 140 (of FIG. 3) containing a plurality of discs 110 (of FIG. 3) to the caddy escapement 158. The caddy escapement 158 engages the disc caddy 140, grips the disc caddy 140, and transports the disc caddy 140 from the in-feed conveyor 166 to the caddy feed 160. The caddy feed 160 secures the disc caddy 140 from the caddy escapement 158, and indexes the disc caddy 140 to a predetermined location, thereby presenting a first disc 110 of plurality of discs to a predetermined, substantially fixed location for use in assembling the DSD 100 (of FIG. 1).

After the first disc 110 of a plurality of discs has been withdrawn from the disc caddy 140, the caddy feed 160 indexes the disc caddy to a second predetermined location, thereby presenting a second disc 110 of plurality of discs to the predetermined, substantially fixed location for use in assembling the DSD 100. Once each of the discs 110 have been extracted from the disc caddy 140, the caddy feed 160 positions the disc caddy 140 onto the out-feed conveyor 170. The out-feed conveyor 170 transports the disc caddy 140 away from the caddy feed 160, and presents the disc caddy 140 for return to a disc manufacturing source for reuse of the disc caddy 140.

FIG. 6 shows that the caddy escapement 158 includes an escapement mount plate 172, which is attached the frame 154. The escapement mount plate 172 supports a caddy present sensor 174 and a pneumatically operated slide assembly 176. The pneumatically operated slide assembly 176 positions an active clamp bar 178 adjacent the disc caddy 140 (of FIG. 3) in response to the caddy present sensor 174 detecting presence of the disc caddy 140, thereby confining the disc caddy 140 adjacent the in-feed conveyor 166.

A bar code reader 180 attached to the escapement mount plate 172 determines a type of media present, that is, the type of media present in the form of the discs 110 supported by the disc caddy 140. In response to an identification of a correct media type present within the disc caddy 140, a caddy vacuum attachment 182 of the caddy escapement 158 secures the disc caddy 140. The active clamp bar 178 is released from contact with the disc caddy 140 by the pneumatically operated slide assembly 176, and the caddy vacuum attachment 182 transports the disc caddy 140 to the caddy feed 160. It is noted that, the caddy vacuum attachment 182 is secured to the escapement mount plate 172, which in turn is secured to the frame 154.

Upon alignment by the caddy vacuum attachment 182 of the disc caddy 140 adjacent the caddy feed 160, a caddy gripper 184 of the caddy feed 160 secures the disc caddy 140 from the caddy vacuum attachment 182. With the disc caddy 140 secured by the caddy gripper 184, a feed elevator 186 (supporting the caddy gripper 184 and attached to the frame 154) indexes the disc caddy 140 to a predetermined location, thereby presenting a first disc 110 of plurality of discs to a predetermined, substantially fixed location for use and assembling the DSD 100.

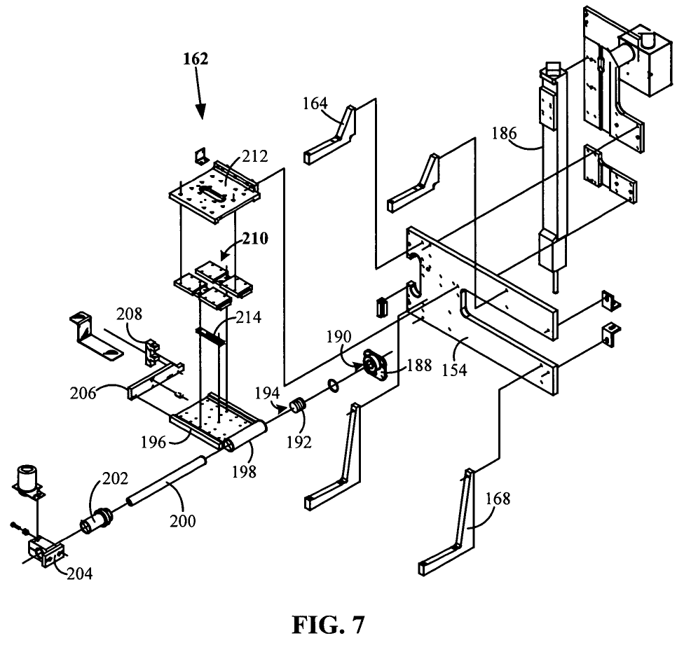

FIG. 7 shows that the alignment assembly 162 includes a main mount 188 with a first main mount aperture 190 aligned for confinement by the frame 154. A compression spring 192 with a second main mount aperture 194 is positioned between the main mount 188 and a feed mount plate 196, which includes an attached main shaft support 198. A main shaft 200 extends through the main shaft support 198, the compression spring 192, and is adjustably secured to the main mount 188.

Supported by the main shaft 200 is a side adjustment nut 202 that pressingly engages the feed mount plate 196 and is retained on the main shaft 200 by a shaft support 204. The side adjustment nut 202 selectively positions the feed mount plate 196 relative to the frame 154 in a first lateral direction over a spring range of the compression spring 192. Interaction between the side adjustment nut 202 and the compression spring 192 selectively determines the first lateral direction of the feed mount plate 196 relative to the frame 154.

Further included in the alignment assembly 162 is a stabilizer bar 206 secured to the feed mount plate 196, an adjuster block 208 supported by the stabilizer bar 206, a slide assembly 210 affixed between the feed mount plate 196 and a feeder mount table 212, and a table lock 214 attached to the slide assembly 210 and adjustably secured to the feed mount plate 196. The slide assembly 210 selectively positions the feeder mount table 212 relative to the feed mount plate 196 in a second lateral direction different than the first lateral direction. The table lock 214 secures the feeder mount table 212 relative to the feed mount plate 196, and the adjuster block 208 communicates with the feeder mount table 212 to provide pitch adjustment of the feeder mount table 212 relative to the frame 154.

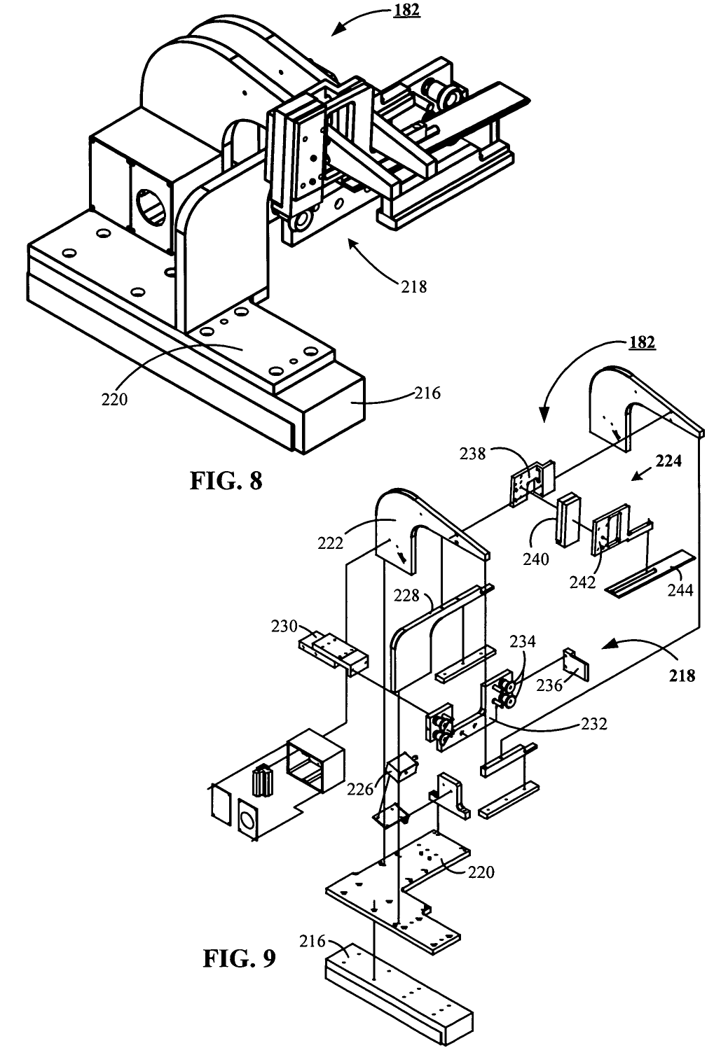

FIG. 8 shows that the caddy vacuum attachment 182 includes a guided cylinder 216 and a vacuum-grasp assembly 218. The vacuum-grasp assembly 218 secures the disc caddy 140 (of FIG. 3) supported by the in-feed conveyor 166 (of FIG. 5), and in the guided cylinder 216 transports the disc caddy 140 from the in-feed conveyor 166 to the caddy gripper 184 (of FIG. 6) of the caddy feed 160 (of FIG. 6).

FIG. 9 shows a caddy vacuum-grasp mounting plate 220 attached to the guided cylinder 216. The caddy vacuum-grasp mounting plate 220 supports a vacuum-grasp support plate 222 with an attached disc retention mechanism 224, and a disc scanner 226. A vacuum cup support plate 228 supporting the vacuum-grasp assembly 218 is secured between the caddy vacuum-grasp mounting plate 220 and the vacuum-grasp support plate 222.

The vacuum-grasp assembly 218 includes; a slide rail 230 fastened to the vacuum cup support plate 228, a vacuum cup mounting plate 232 attached to the slide rail 230, a plurality of vacuum cups 234 adapted to the vacuum cup mounting plate 232, and a caddy bottom support 236 joined to the vacuum cup mounting plate 232. While the disc retention mechanism 224 includes a disc retainer slide mount 238 supporting a disc retainer slide 240, a disc retention bar mount 242, and a disc retention bar 244 connected to the disc retention bar mount 242.

In response to the disc scanner 226 detecting a locational presence of the first disc of the plurality of discs 110 (of FIG. 3), the disc retainer slide 240 responds by positioning the disc retention bar 244 adjacent the plurality of discs 110 to preclude the discs 110 from “walking out” of the disc caddy during transport of the disc caddy 140.

In response to the bar code reader 180 (of FIG. 6), the slide rail 230 advances the vacuum cup mounting plate 232 such that the vacuum cups 234 are pressingly engaged into mating contact with a side of the disc caddy 140. While the vacuum cups 234 are engaged with the side of the disc caddy 140, the caddy bottom support 236 is slid beneath a bottom of a disc caddy 140. With the vacuum cups 234 and the caddy bottom support 236 position adjacent the disc caddy 140, and with the disc retention bar 244 positioned adjacent the discs 110, a vacuum is drawn on the vacuum cups 234 to secure the disc caddy 140 adjacent the caddy vacuum attachment 182. With the disc caddy 140 secured by the vacuum-grasp assembly 218, the guided cylinder 216 transports the captured disc caddy 140 to the caddy feed 160.

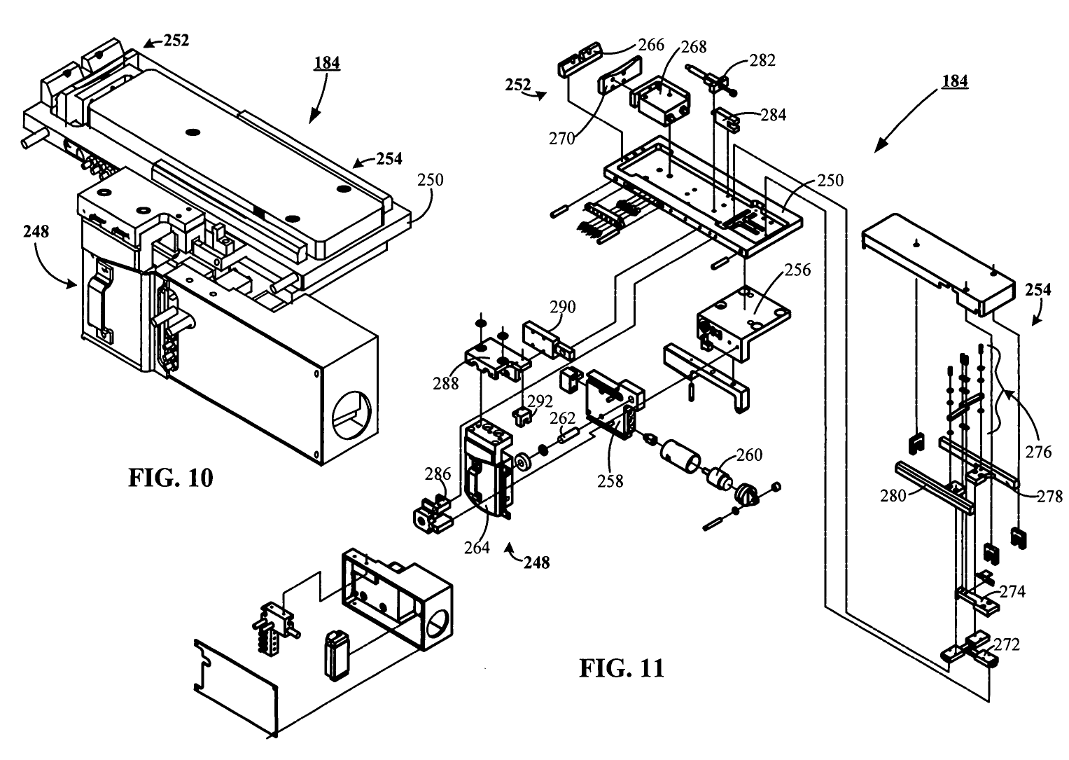

FIG. 10 shows that the caddy gripper 184 includes a gripper slide assembly 248 supporting a gripper plate 250, which supports both an active jaw assembly 252 and a caddy locating assembly 254. Upon positioning by the caddy escapement 158 (of FIG. 4) of the disc caddy 140 (of FIG. 3) adjacent the caddy gripper 184 of the caddy feed 160 (of FIG. 6), the gripper slide assembly 248 advances the gripper plate 250 into mating contact with the disc caddy 140. With the gripper plate 250 position adjacent the disc caddy 140, the caddy locating assembly 254 aligns the disc caddy 140 relative to the gripper plate 250, and the active jaw assembly 252 preferably engages a top side of a disc caddy 140, thereby gripping the disc caddy 140 adjacent the gripper plate 250.

FIG. 11 shows a slide mount 256 used to attach the caddy gripper 184 to the feed elevator 186 (of FIG. 6) while providing a mounting surface for the gripper slide assembly 248. The gripper slide assembly 248 includes; an arm pivot block 258, a pivot cylinder 260 affixed to the arm pivot block 258, a pivot pin 262 communicating with the arm pivot block 258, and a gripper slide 264 supported by the pivot pin 262 and attached to the gripper plate 250. Upon gripping of the disc caddy 140 (of FIG. 3) by the active jaw assembly 252, the vacuum-grasp assembly 218 (of FIG. 9) releases the vacuum drawn on the vacuum cups 234 (of FIG. 9), and the gripper slide 264 retracts the disc caddy 140 from the caddy escapement 158 (of FIG. 4). With the disc caddy 140 retracted from the caddy escapement 158, the pivot cylinder 260 rotates the arm pivot block 258, thereby aligning the disc caddy 140 for presentation of the discs 110 (of FIG. 3) for use in assembling the DSD 100 (of FIG. 1).

It is noted that, during the process of indexing each disc 110 to the predetermined substantially fixed point of use, the disc retention bar 244 (of FIG. 9) remains adjacent the plurality of discs 110. That is, the disc retainer slide 240 (of FIG. 9) further extends the disc retention bar 244. With the exception of the disc 110 being accessed for use in assembling the DSD 100, each of the plurality of discs 110 confined by the disc caddy 140 are precluded by the disc retention bar 244 from escaping the confines of the disc caddy 140 during the indexing process.

FIG. 11 further shows the active jaw assembly 252 includes a first jaw portion 266 affixed to the gripper plate 250, a jaw slide 268 attached to the gripper plate 250, and a second jaw portion 270 secured to the jaw slide 268. Upon advancement by the gripper slide 264 of the gripper plate 250 into mating contact with the disc caddy 140, the jaw slide 268 advances the second jaw portion 270 into an active clamping engagement with the top side of the disc caddy 140. Thereby gripping the disc caddy 140 between the first jaw portion 266 and the second jaw portion 270.

Also shown by FIG. 11 is an exploded view of the caddy locating assembly 254. The caddy locating assembly 254 includes; a datum slide assembly 272 attached to the gripper plate 250, a datum actuator plate 274 secured to the datum slide assembly 272, an activation linkage 276 communicating with the datum actuator plate 274, a first datum bar 278 and a second datum bar 280 each affixed to the activation linkage 276, a datum cylinder 282 mounted to the gripper plate 250 and affixed to the datum actuator plate 274, and an optical sensor 284 attached to the gripper plate 250 detecting a position of the datum bars 278 and 280.

Upon advancement by the gripper slide 264 of the gripper plate 250 into mating contact with the disc caddy 140, the datum cylinder 282 advances the datum actuator plate 274, which interacts with the activation linkage 276 thereby advancing the datum bars 278 and 280 into engagement with sidewalls of the disc caddy 140. Engagement of the sidewalls of the disc caddy 140 by the advancement of the datum bars 278 and 280 aligns the disc caddy 140 relative to the gripper plate 250. The optical sensor 284 determines compliance of the datum bars 278 and 280 with a predetermined location, which confirms substantial alignment of the disc caddy 140 to the gripper plate 250.

As shown by FIG. 11, the caddy gripper 184 further includes; an over-travel vane 286 attached to the gripper plate 250, a sensor mount 288 secured to the gripper slide 264, an over-travel slide 290 affixed to the gripper plate 250 and secured to the gripper slide 264, and an over-travel sensor 292 mounted to the sensor mount 288. Upon encountering an encumbrance to travel of the disc caddy 140 during the indexing process, the over-travel vane 286 activates the over-travel sensor 292. Upon activation of the over-travel sensor 292, the over-travel sensor 292 sends a halt signal to the feed elevator 186 (of FIG. 6). The feed elevator 186 discontinues the indexing process and alerts an operator to remove the encumbrance.

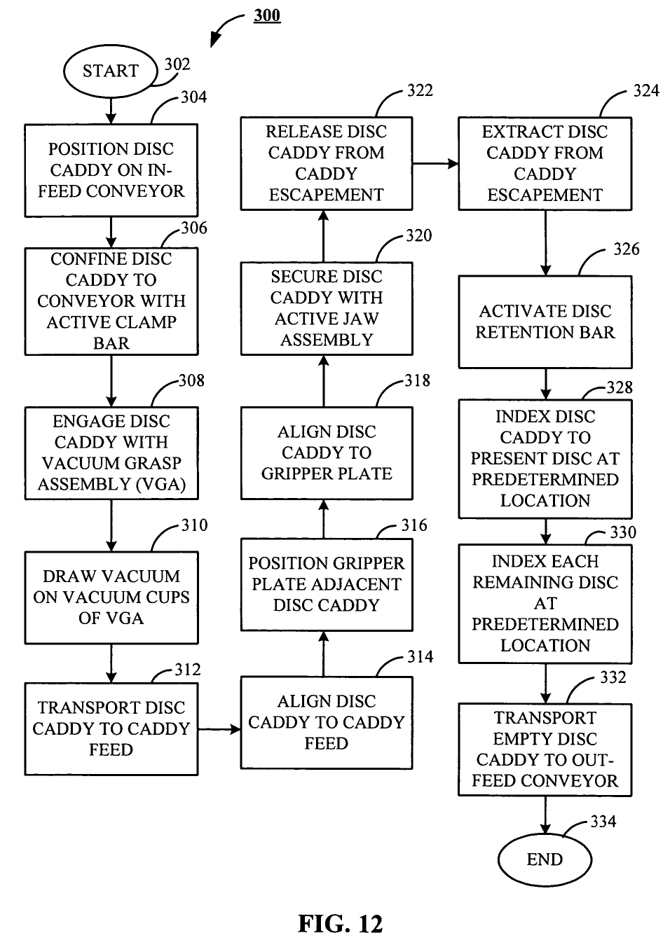

FIG. 12 shows a preferred disc presentation process 300 commencing at start step 302 and continuing at process step 304 by positioning a disc caddy (such as 140) on an in-feed conveyor (such as 166). Preferably, the in-feed conveyor conveys each of a plurality of disc caddies (such as 140) at an angle of a substantially 3° from vertical to preclude discs (such as 110) from escaping the disc caddy during conveyance of each disc caddy. At process step 306, the disc caddy is confined by an active clamp bar (such as 178), which confines the disc caddy adjacent the in-feed conveyor while awaiting pick-up by a caddy escapement (such as 158). At process step 308, the caddy escapement engages a side of the disc caddy with a vacuum-grasp assembly (such as 218). At process step 310 a vacuum is drawn on vacuum cups (such as 234), which secures the disc caddy to the vacuum-grasp assembly. At process step 312, the caddy escapement transports the disc caddy from the in-feed conveyor to a caddy feed (such as 160).

At process step 314, the caddy escapement aligns the disc caddy with the caddy feed. At process step 316, a caddy gripper (such as 184) activates a gripper slide assembly (such as 248), which advances a gripper plate (such as 250) into contact with the disc caddy. At process step 318, the caddy gripper activates a caddy locating assembly (such as 254), which aligns the disc caddy relative to the gripper plate. At process step 320, the caddy gripper activates an active jaw assembly (such as 252), which preferably grips the top side of the disc caddy.

The disc presentation process 300 preferably continues at process step 322, with the caddy escapement discontinuing the vacuum being drawn on the vacuum cups to release the disc caddy from the caddy escapement. At process step 324, the gripper slide assembly extracts the disc caddy from the caddy escapement. At process step 326, the caddy escapement further extends a disc retainer slide (such as 240), which realigns the disc retention bar adjacent the discs, which precludes inadvertent escapement of the discs from the disc caddy. At process step 328, a feed elevator (such as 186) preferably indexes the disc caddy to a predetermined location, which presents a first disc of the plurality of discs at a predetermined substantially fixed location for use in assembling a data storage device (such as 100). At process step 330, the feed elevator successively indexes each of the remaining discs for use in assembling the data storage device. At process step 332, the feed elevator transfers the empty caddy to an out-feed conveyor (such as 170), the out-feed conveyor transports the empty disc caddy to an outer extent of the disc caddy feeder system with a caddy gripper (such as 148), and the disc presentation process 300 concludes at end process step 334.

Accordingly, in preferred embodiments, the present invention is directed to a disc presentation apparatus (such as 148), a method of presenting the disc (such as 300), and an apparatus (such as 184) for gripping a disc caddy (such as 140). The disc presentation apparatus includes a frame (such as 154) supporting an in-feed conveyor (such as 166), which advances the disc caddy (which includes at least one disc (such as 110) confined within the disc caddy) to a caddy escapement (such as 158). The caddy escapement secures the disc caddy from the in-feed conveyor and transports the disc caddy to a caddy feed (such as 160). Also included in the disc presentation apparatus is an out-feed conveyor (such as 170), which preferably receives empty disc caddies from the caddy feed and transports them to an outer extent of the presentation apparatus.

The steps of the disc presentation method preferably include; positioning a disc caddy confining a disc on an in-feed conveyor (such as by step 306), securing the disc caddy with a caddy escapement (such as by step 308), transferring the disc caddy secured by the caddy escapement to a caddy feed (such as by step 314), extracting the disc caddy from the caddy escapement with means (such as 184) for gripping a disc caddy (such as by step 324), indexing the disc to a predetermined substantially fixed location (such as by step 330), and transferring the disc caddy to an out-feed conveyor (such as by step 332).

The means of gripping the disc caddy is the apparatus, which preferably includes; a slide mount (such as 256), a gripper slide (such as 264) attached to the slide mount, a gripper plate (such as 250) secured to the gripper slide assembly, an active jaw assembly (such as 252) fastened to the gripper plate and a caddy locating assembly (such as 254). Preferably the gripper slide assembly advances the gripper plate into mating contact with the disc caddy, the caddy locating assembly aligns the disc caddy relative to the gripper plate, and the active jaw assembly engages a first side of the disc caddy thereby gripping the disc caddy adjacent the gripper plate.

It is to be understood that even though numerous characteristics and advantages of various embodiments of the present invention have not been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad ordinary meaning of the terms in which the appended claims are expressed. For example, the particular elements may vary depending on the particular dimension of the discs while maintaining substantially the same functionality without departing from the scope and spirit of the present invention. In addition, although the preferred embodiment described herein is directed to a disc caddy feeder system with a caddy gripper for use in assembling a data storage device, it will be appreciated by those skilled in the art that the teachings of the present invention can be applied to other systems, such as handling integrated circuit wafers, without departing from the scope and spirit of the present invention.

What is claimed is:

1. A disc presentation apparatus comprising:
a frame supporting an in-feed conveyor advancing a disc caddy confining a disc;
a caddy escapement supported by the frame comprising an active clamp bar confining the disc caddy adjacent said conveyor, and a mechanism securing the disc caddy from said conveyor; and
a caddy feed comprising a feed elevator supported by the frame and a caddy gripper attached to the feed elevator, the caddy gripper gripping the disc caddy from the mechanism, and wherein the caddy gripper secures and aligns the disc caddy in a predetermined orientation, and further in which the feed elevator advances the disc caddy secured by the caddy gripper, thereby presenting the disc at a predetermined substantially fixed location.

2. The apparatus of claim 1, in which the frame further supports an alignment assembly comprising:
a main mount with a first main shaft aperture confined by the frame;
a compression spring with a second main shaft aperture adjacent the main mount;
a feed mount plate with an attached main shaft support adjacent the compression spring;
a main shaft extending through the main shaft support, each of the said main shaft apertures and adjustably secured to the main mount;
a side adjustment nut slidingly engaging the main shaft and pressingly engaging the feed mount plate; and
a shaft support adjacent the side adjustment nut and secured to the main shaft, wherein the side adjustment nut selectively positions the feed mount plate relative to the frame in a first lateral direction over a spring range of the compression spring, the compression spring restrains rotation of the feed mount plate about the main shaft, and an interaction between the side adjustment nut and the compression spring selectively determines the first lateral direction of the feed mount plate relative to the frame.

3. The apparatus of claim 2, the alignment assembly further comprising:
a stabilizer bar secured to the feed mount plate;
an adjuster block affixed to the stabilizer bar;
a slide assembly secured to the feed mount plate;
a feeder mount table attached to the slide assembly; and
a table lock affixed to the slide assembly and adjustably secured to the feed mount plate, the slide assembly selectively positions the feeder mount table relative to the feed mount plate in a second lateral direction different than the first lateral direction relative to the frame, wherein the table lock secures the feed mount table in a determined position relative to the feed mount plate, and wherein the adjuster block communicating with the feed mount table provides pitch adjustment of the feed mount table relative to the frame.

4. The apparatus of claim 1, the caddy escapement further comprising:
an escapement mount plate attached to the frame;
a caddy present sensor supported by the escapement plate detecting presence of the disc caddy;
a pneumatically operated slide assembly responsive to the caddy present sensor positioning the active clamp bar in pressing contact with the disc caddy; and
a barcode reader attached to the escapement plate determining a disc type of the disc.

5. The apparatus of claim 1, in which the mechanism is a caddy vacuum attachment comprising:
a guided cylinder affixed to an escapement mount plate, the escapement mount plate attached to the frame while supporting a caddy present sensor;
a caddy vacuum-grasp mounting plate attached to the guided cylinder;
a vacuum-grasp support plate secured to the caddy vacuum-grasp mounting plate;
a disc retention mechanism mounted to the vacuum-grasp support plate;
a vacuum-grasp assembly mounted to the vacuum-grasp support plate; and
a disc scanner attached to the caddy vacuum-grasp mounting plate detecting presence of the disc caddy, wherein the guided cylinder responding to the caddy present sensor positions the vacuum-grasp assembly adjacent the disc caddy, the vacuum-grasp assembly grasping the disc caddy.

6. The apparatus of claim 5, in which the disc retention mechanism comprises:
a disc retainer side mount attached to the vacuum-grasp support plate;
a disc retainer slide attached to the disc retainer side mount;
a disc retention bar mount secured to the disc retention slide; and
a disc retention bar affixed to the disc retention bar mount, wherein the disc retainer slide positions the disc retention bar adjacent the disc.

7. The apparatus of claim 5, in which the vacuum-grasp assembly comprises:
a slide rail fastened to the caddy vacuum-grasp mounting plate;
a vacuum cup mount plate fixed to the slide rail;
a vacuum cup adapted to the vacuum cup mount plate; and
a caddy bottom support joined to the vacuum cup mount plate, wherein the slide rail pressingly engages the vacuum cup into mating contact with a side of the disc caddy while sliding the caddy bottom support into supporting contact with a bottom of the disc caddy, and
wherein the vacuum cup grasps the side of the disc caddy while the caddy bottom support supports the bottom of the disc caddy.

8. The apparatus of claim 1, wherein upon the caddy escapement positioning the disc caddy adjacent the caddy gripper, the caddy gripper grips the disc caddy from the mechanism, and in which the caddy gripper comprises:
a slide mount supported by the caddy elevator;
a gripper slide assembly attached to the slide mount;
a gripper plate secured to the gripper slide assembly;
an active jaw assembly fastened to the gripper plate; and
a caddy locating assembly supported by the gripper plate, wherein upon positioning of the caddy adjacent the caddy gripper, the gripper slide assembly advancing the gripper plate into mating contact with the disc caddy, the caddy locating assembly aligning the disc caddy relative to the gripper plate, and the active jaw assembly engaging a first side of the disc caddy thereby gripping the disc caddy adjacent the gripper plate.

9. The apparatus of claim 8, in which the gripper slide assembly comprises:
an arm pivot block attached to the slide mount;
a pivot cylinder affixed to the arm pivot block;
a pivot pin communicating with the arm pivot block and responsive to the pivot cylinder; and
a gripper slide supported by the pivot pin and attached to the gripper plate, wherein upon the jaw assembly gripping the disc caddy, the gripper slide retracts the disc caddy from the caddy escapement, and the pivot cylinder rotates the pivot block thereby aligning the disc caddy for presentation of the disc.

10. The apparatus of claim 8, in which the active jaw assembly comprises:
a first jaw portion affixed to the gripper plate;
a jaw slide attached to the gripper plate; and
a second jaw portion secured to the jaw slide, wherein upon advancement of the gripper plate into mating contact with the disc caddy, the jaw slide advances the second jaw portion into an active clamping engagement with the first side of the disc caddy thereby gripping the disc caddy between the first and second jaw portions and adjacent the gripper plate.

11. The apparatus of claim 8, in which the caddy locating assembly comprises:
a datum slide assembly attached to the gripper plate;
a datum actuator plate secured to the datum slide assembly;
an activation linkage communicating with the datum actuator plate;
a datum bar movably affixed to the activation linkage;
a datum cylinder mounted to the gripper plate and affixed to the datum actuator plate; and
an optical sensor mounted to the gripper plate detecting a position of the datum bar, wherein upon advancement of the gripper plate into mating contact with the disc caddy, the datum cylinder advances the datum actuator plate which interacts with the activation linkage thereby advancing the datum bar into engagement with a second side of the disc caddy thereby aligning the disc caddy relative to the gripper plate, wherein the optical sensor determines compliance of the datum bar relative to the disc caddy.

12. The apparatus of claim 8, in which the caddy gripper further comprises:
an over-travel vane attached to the gripper plate;
a sensor mount secured to the gripper slide;
an over-travel slide affixed between the gripper plate and secured to the gripper slide; and
an over-travel sensor mounted to the sensor mount, wherein upon encountering an encumbered travel of the disc caddy during indexing of the disc caddy by the feed elevator, the over-travel vane activates the over-travel sensor, the over-travel sensor signals the feed elevator, and the feed elevator suspends indexing of the disc caddy.

13. The apparatus of claim 1 further comprising an out-feed conveyer supported by the frame, the out-feed conveyer communicating with the caddy gripper transferring the disc caddy from the caddy feed.

14. An apparatus for gripping a disc caddy comprising:
a slide mount;
a gripper slide assembly attached to the slide mount;
a gripper plate secured to the gripper slide assembly;
an active jaw assembly fastened to the gripper plate; and
a caddy locating assembly supported by the gripper plate, wherein the gripper slide assembly advances the gripper plate into mating contact with the disc caddy, the caddy locating assembly aligning the disc caddy relative to the gripper plate, and the active jaw assembly engaging a first side of the disc caddy thereby gripping the disc caddy adjacent the gripper plate.

15. The apparatus of claim 14, wherein the disc caddy confines a disc, and in which the gripper slide assembly comprises:
an arm pivot block attached to the slide mount;
a pivot cylinder affixed to the arm pivot block;
a pivot pin communicating with the arm pivot block and responsive to the pivot cylinder; and
a gripper slide supported by the pivot pin and attached to the gripper plate, wherein upon the jaw assembly gripping the disc caddy, the gripper slide repositions the disc, and the pivot cylinder rotates the pivot block thereby aligning the disc caddy for presentation of the disc.

16. The apparatus of claim 14, in which the active jaw assembly comprises:
a first jaw portion affixed to the gripper plate;
a jaw slide attached to the gripper plate; and
a second jaw portion secured to the jaw slide, wherein upon advancement by the gripper slide assembly of the gripper plate into mating contact with the disc caddy, the jaw slide advances the second jaw portion into an active clamping engagement with a first side of the disc caddy thereby gripping the disc caddy between the first and second jaw portions and adjacent the gripper plate.

17. The apparatus of claim 14, in which the caddy locating assembly comprises:
a datum slide assembly attached to the gripper plate;
a datum actuator plate secured to the datum slide assembly;
an activation linkage communicating with the datum actuator plate;
a datum bar movably mounted to the activation linkage;
a datum cylinder affixed between the gripper plate and the datum actuator plate; and
an optical sensor mounted to the gripper plate detecting a position of the datum bar, wherein upon advancement of the gripper plate into mating contact with the disc caddy, the datum cylinder advances the datum actuator plate which interacts with the activation linkage thereby advancing the datum bar into engagement with a second side of the disc caddy thereby aligning the disc caddy relative to the gripper plate, wherein the optical sensor determines compliance of the datum bar relative to the disc caddy.

18. The apparatus of claim 14 further comprising:
an over-travel vane attached to the gripper plate;
a sensor mount secured to the gripper slide;
an over-travel slide affixed between the gripper plate and the gripper slide;
and
an over-travel sensor mounted to the sensor mount, wherein upon an encumbered movement of the disc caddy, the over-travel vane activates the over-travel sensor, and the over-travel sensor suspends the encumbered movement of the disc caddy.

19. A method comprising:
positioning a disc caddy confining a disc on an in-feed conveyor;
securing the disc caddy with a caddy escapement;
transferring the disc caddy secured by the caddy escapement to a caddy feed;
extracting the disc caddy from the caddy escapement with means for gripping a disc caddy;
indexing the disc to a predetermined substantially fixed location; and
transferring the disc caddy to an out-feed conveyor.

20. The method of claim 19, in which the means for gripping a disc caddy comprises:
a slide mount;
a gripper slide assembly attached to the slide mount;
a gripper plate secured to the gripper slide assembly;
an active jaw assembly fastened to the gripper plate; and
a caddy locating assembly supported by the gripper plate comprising:
a datum slide assembly attached to the gripper plate;
a datum actuator plate secured to the datum slide assembly;
an activation linkage communicating with the datum actuator plate;
a datum bar movably mounted to the activation linkage;
a datum cylinder affixed between the gripper plate and the datum actuator plate; and
an optical sensor mounted to the gripper plate detecting a position of the datum bar, wherein the gripper slide assembly advances the gripper plate into mating contact with the disc caddy, the caddy locating assembly aligning the disc caddy relative to the gripper plate, and the active jaw assembly engaging a first side of the disc caddy thereby gripping the disc caddy adjacent the gripper plate, and wherein upon advancement of the gripper plate into mating contact with the disc caddy, the datum cylinder advances the datum actuator plate which interacts with the activation linkage thereby advancing the datum bar into engagement with a second side of the disc caddy thereby aligning the disc caddy relative to the gripper plate, wherein the optical sensor determines compliance of the datum bar relative to the disc caddy.

21. An apparatus presenting a disc confined by a disc caddy comprising a caddy vacuum attachment securing the disc caddy, and means for presenting the disc at a predetermined substantially fixed location.

22. The apparatus of claim 21, in which the means for presenting the disc at a predetermined substantially fixed location comprises a feed elevator supporting a caddy gripper comprising:
a slide mount supported by the caddy elevator;
a gripper slide assembly attached to the slide mount;
a gripper plate secured to the gripper slide assembly;
an active jaw assembly fastened to the gripper plate; and
a caddy locating assembly supported by the gripper plate, the gripper slide assembly advancing the gripper plate into mating contact with the disc caddy, the caddy locating assembly aligning the disc caddy relative to the gripper plate, and the active jaw assembly engaging a first side of the disc caddy thereby gripping the disc caddy adjacent the gripper plate.
